(19) United States
(12) Patent Application Publication
(10) Pub. No.: US 2024/0320376 A1
(43) Pub. Date: Sep. 26, 2024

(54) DIGITAL ENTITY PROCESSING METHOD, ELECTRONIC DEVICE, STORAGE MEDIUM

(71) Applicant: TENCENT TECHNOLOGY (SHENZHEN) COMPANY LIMITED, Shenzhen (CN)

(72) Inventor: Jinhui ZENG, Shenzhen (CN)

(21) Appl. No.: 18/734,593

(22) Filed: Jun. 5, 2024

Related U.S. Application Data
(63) Continuation of application No. PCT/CN2023/094699, filed on May 17, 2023.

(30) Foreign Application Priority Data
Jul. 29, 2022 (CN) 202210913825.7

(51) Int. Cl. G06F 21/64

(52) U.S. Cl. CPC G06F 21/64

(57) ABSTRACT

A digital entity processing method, performed by an electronic device, includes obtaining, when an operation request initiated by a target object for a digital entity is obtained, a digital identifier of the target object, the operation request carrying operation information of a target operation requested by the target object; generating an entity operation credential based on the digital identifier of the target object and the operation information, the entity operation credential indicating a request for performing the target operation for the digital entity, and indicating that a requester of the target operation is the target object; obtaining statement data in response to the target object confirming that the target operation is performed on the digital entity, the statement data being obtained by signing the entity operation credential using first signature data of the target object; and performing the target operation on the digital entity.

### CROSS-REFERENCES TO RELATED APPLICATIONS

This application is a continuation application of PCT Patent Application No. PCT/CN2023/094699, filed on May 17, 2023, which claims priority to Chinese Patent Application No. 2022109138257, filed on Jul. 29, 2022, all of which is incorporated by reference in their entirety.

### FIELD OF THE TECHNOLOGY

The present disclosure relates to the field of computer technologies, and in particular, to a digital entity processing technology.

### BACKGROUND OF THE DISCLOSURE

A digital entity is a digitized entity that is uniquely identified based on a blockchain technology. Compared with an actual entity, the digital entity has advantages of portability, dissemination, permanent storage, and the like.

Currently, operations such as minting, publishing, or transfer of the digital entity are supported to implement minting and circulation of the digital entity. However, when operations are performed on the digital entity, problems, such as security of the digital entity and traceability of the operations, are not considered. Operators often directly perform operations (such as transferring) on the digital entity, while no operation recording mechanism has been set up correspondingly in the background. There is a need to provide a digital entity processing method, apparatus, electronic device, storage medium, and program product with desirable security and traceability.

### SUMMARY

One embodiment of the present disclosure includes a digital entity processing method, performed by an electronic device. The method includes obtaining, when an operation request initiated by a target object for a digital entity is obtained, a digital identifier of the target object, the operation request carrying operation information of a target operation requested by the target object performing for the digital entity; generating an entity operation credential based on the digital identifier of the target object and the operation information, the entity operation credential indicating a request for performing the target operation for the digital entity, and indicating that a requester of the target operation is the target object; obtaining statement data in response to the target object confirming that the target operation is performed on the digital entity, the statement data being obtained by signing the entity operation credential using first signature data of the target object; and performing the target operation on the digital entity based on the statement data.

Another embodiment of the present disclosure includes an electronic device. The electronic device includes at least one processor, configured to execute a computer program; and a memory storing the computer program that, when being executed, causes the at least one processor to perform: obtaining, when an operation request initiated by a target object for a digital entity is obtained, a digital identifier of the target object, the operation request carrying operation information of a target operation requested by the target object performing for the digital entity; generating an entity operation credential based on the digital identifier of the target object and the operation information, the entity operation credential indicating a request for performing the target operation for the digital entity, and indicating that a requester of the target operation is the target object; obtaining statement data in response to the target object confirming that the target operation is performed on the digital entity, the statement data being obtained by signing the entity operation credential using first signature data of the target object; and performing the target operation on the digital entity based on the statement data.

Another embodiment of the present disclosure includes a non-transitory computer-readable storage medium, containing a computer application program that, when being executed, causes a computer to perform: obtaining, when an operation request initiated by a target object for a digital entity is obtained, a digital identifier of the target object, the operation request carrying operation information of a target operation requested by the target object performing for the digital entity; generating an entity operation credential based on the digital identifier of the target object and the operation information, the entity operation credential indicating a request for performing the target operation for the digital entity, and indicating that a requester of the target operation is the target object; obtaining statement data in response to the target object confirming that the target operation is performed on the digital entity, the statement data being obtained by signing the entity operation credential using first signature data of the target object; and performing the target operation on the digital entity based on the statement data.

### BRIEF DESCRIPTION OF THE DRAWINGS

FIG. 1a is a schematic diagram of a structure of a blockchain according to an exemplary embodiment of the present disclosure.

FIG. 1b is a schematic diagram of a structure of a data sharing system according to an exemplary embodiment of the present disclosure.

FIG. 2a is a schematic diagram of an architecture of a digital entity processing system according to an exemplary embodiment of the present disclosure.

FIG. 2b is a schematic diagram of a structure of a blockchain application protocol model according to an exemplary embodiment of the present disclosure.

FIG. 2c is a schematic diagram of a protocol mapping relationship between an NFT smart contract and a DID smart contract according to an exemplary embodiment of the present disclosure.

FIG. 2d is a schematic diagram of a DID protocol-based NFT protocol design according to an exemplary embodiment of the present disclosure.

FIG. 3 is a schematic flowchart of a digital entity processing method according to an exemplary embodiment of the present disclosure.

FIG. 4 is a schematic diagram of outputting an entity operation credential according to an exemplary embodiment of the present disclosure.

FIG. 5 is a schematic flowchart of another digital entity processing method according to an exemplary embodiment of the present disclosure.

FIG. 6 is a schematic flowchart of minting a digital entity according to an exemplary embodiment of the present disclosure.

FIG. 7 is a schematic flowchart of still another digital entity processing method according to an exemplary embodiment of the present disclosure.

FIG. 8 is a schematic flowchart of transferring a digital entity according to an exemplary embodiment of the present disclosure.

FIG. 9 is a schematic diagram of a structure of a digital entity processing apparatus according to an exemplary embodiment of the present disclosure.

FIG. 10 is a schematic diagram of a structure of an electronic device according to an exemplary embodiment of the present disclosure.

### DESCRIPTION OF EMBODIMENTS

The technical solutions in embodiments of the present disclosure are clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

Embodiments of the present disclosure provide a digital entity processing method. The processing method mainly relates to a blockchain technology, and specifically, to a typical application in the blockchain technology. The typical application includes a decentralized identity (DID) and a non-fungible token (NFT).

The following briefly describes the technical terms and concepts of the embodiments of the present disclosure.

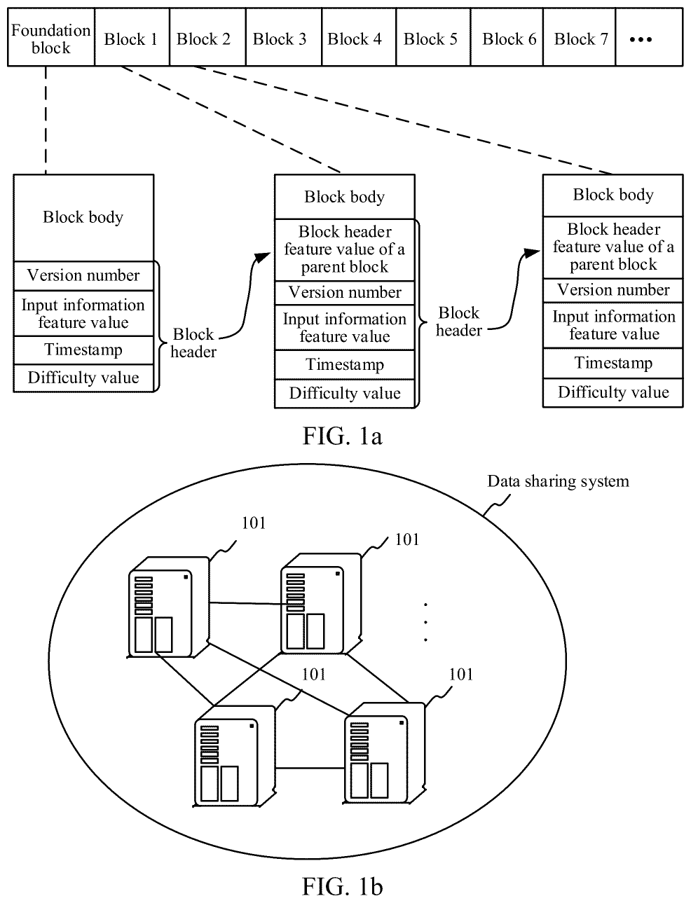

(1) Blockchain: It is the basis of a blockchain technology. The blockchain is a new application mode of a computer technology such as decentralized data storage, point-to-point transmission, consensus mechanism, and encryption algorithm. The blockchain is essentially a decentralized database or a string of data blocks produced by using cryptographic methods. Each data block includes a batch of network transaction information to verify information validity (anti-counterfeiting) of the transaction information and generate a next block. For a schematic diagram of a structure of a blockchain, reference may be made to FIG. 1a. As shown in FIG. 1a, the blockchain includes a plurality of blocks. A first block of the blockchain is referred to as a foundation block. The foundation block includes a block header and a block body. The block header stores an input information feature value, a version number, timestamp, and a difficulty value. The block body stores input information. A next block of the foundation block uses the foundation block as a sub-block. In other words, the foundation block is a parent block of the next block. The next block also includes a block header and a block body. The block header stores a block header feature value of the parent block, and an input information feature value, a version number, timestamp, and a difficulty value of a current block, and so on. This enables block data stored in blocks in the blockchain to be associated with block data stored in the parent block, thereby ensuring security of input information in a block.

The blockchain can be maintained by blockchain nodes included in a blockchain network. The blockchain network may be understood as a data sharing system, and refers to a system configured to implement data sharing between the blockchain nodes. For an exemplary structure of the data sharing system, refer to FIG. 1b. As shown in FIG. 1b, the data sharing system may include a plurality of blockchain nodes 101. Each blockchain node 101 may be a server connected to the blockchain network, or may be a terminal connected to the blockchain network (such as a client running in the terminal). A specific form of the blockchain node 101 is not limited herein. Each blockchain node 101 in the blockchain network has a corresponding node identifier, and the blockchain node 101 in the blockchain network can store a node identifier of another blockchain node 101 in the blockchain network. This facilitates broadcasting a generated block to another blockchain node 101 in the data sharing system based on the node identifier of the another blockchain node 101, to implement decentralized storage of data included in blocks on the blockchain network, to ensure that the data cannot be tampered with, cannot be copied, and is permanently preserved.

\textcircled{1} When a specific service is implemented based on the blockchain network, a smart contract needs to be complied with. The smart contract may refer to a digital protocol that deploys protocol specifications required for service execution on the blockchain network in the form of code. Specifically, the smart contract is deployed on the blockchain nodes in the blockchain network to execute the smart contract by the blockchain nodes, to implement a service corresponding to the smart contract. For example, the service corresponding to the smart contract is a transaction. In other words, the smart contract is a contract used for the transaction. For example, the smart contract includes: checking a logistics status of a good purchased by a consumer, and transferring electronic resources (such as resources used for commodity transactions on the Internet) of the consumer to an address of a merchant after the consumer signs for the good. Then, after the consumer signs for the good, the smart contract (which is specifically code that executes the smart contract) can be executed to transfer the electronic resources (such as resources used for commodity transactions on the Internet) of the consumer to the address of the merchant. Certainly, the above is merely an exemplary smart contract application provided in embodiments of the present disclosure.

\textcircled{2} Blockchains maintained by the blockchain network are mainly divided into three types depending on degree of openness of the blockchain network, including a public blockchain, a consortium blockchain, and a private blockchain. The public blockchain may refer to a blockchain in which any node in the blockchain network (such as a blockchain node corresponding to a single object or a collective object) can send transaction data, the transaction data can be effectively confirmed, and any node can participate in a consensus process. The consortium blockchain may refer to that some nodes in the blockchain network can participate in a block consensus process, while other nodes do not have a blockchain that can access the consensus process. For example, in a blockchain network including a consortium blockchain, a plurality of pre-selected blockchain nodes can be designated as accounting nodes (such as blockchain nodes having consensus permission). Blocks on the consortium blockchain each are decided by all the accounting nodes (in other words, the pre-selected blockchain nodes participate in the consensus process). In addition to the accounting nodes, other connected blockchain nodes in the blockchain network can participate in transactions, but do not participate in the consensus process. The private blockchain may refer to a blockchain in which one blockchain node in the blockchain network has exclusive write permission (such as uploading a block to the blockchain after consensus).

(2) A digital entity may include a non-fungible token (NFT), and is a set of blockchain technology-based digital asset protocols. Specifically, an entity is digitized and put on the blockchain, making the entity be digitalized into a unique, indivisible, and rare digitized entity. For case of description, abbreviation NFT is subsequently used to represent the digital entity. A physical form that can be minted into the digital entity may include, but is not limited to a digital image (or a digital picture), audio and video, a three-dimensional (3D) model, an electronic ticket, a digital souvenir, and the like. The physical form that is minted into the digital entity is not limited in embodiments of the present disclosure. The digital entity is stored on the blockchain and cannot be tampered with or copied, making the digital entity have unique value compared with a physical entity. For example, a digital credential corresponding to the digital entity can be stored on the blockchain, so that provided that the blockchain exists, the digital entity can be stored permanently without being tampered with or copied. For another example, the digital entity exists in the blockchain in a digital form, and is convenient for an owner to carry and disseminate.

In actual application, an interactive operation (or referred to as a target operation) can be performed for the digital entity in the blockchain network, including but not limited to minting of the digital entity, transfer of the digital entity, and the like. The minting of the digital entity refers to using the blockchain technology to digitally encrypt the digital entity, so that the digital entity has a digital credential (or referred to as a serial number, a blockchain number, or the like) that uniquely identifies identity. The digital credential is used as proof of right of a holder to own the digital entity. The digital credential corresponding to the digital entity is then stored on the blockchain to implement a process of uploading the digital entity to the blockchain. The transfer of the digital entity refers to a process of transferring the digital entity from a current holder to another object, so that the another object has permission to operate the digital entity. For example, if the current holder of the digital entity is a target object (such as any object), the target object transfers the digital entity to a reference object (such as another object different from the target object), and the essence is to transfer the operation permission (such as operations of selling and displaying) of the digital entity to the reference object. After the transfer, the reference object has the operation permission to operate the digital entity.

As described above, the smart contract deploys protocol specifications on the blockchain network in the form of code. This enables the target object to access an NFT smart contract on the blockchain network by using a decentralized application (DApp) (such as an NFT wallet) to implement the target operation such as the minting or the transfer of the digital entity (or referred to as digital assets). Specifically, the NFT smart contract follows an NFT smart contract interface protocol standard (such as ERC721 or ERC1155) to facilitate a third-party service (such as an NFT exchange) calling the NFT standard interface to perform interactive operations for the NFT (such as NFT minting, issuance, and buying and selling). In addition, the digital assets are locked in a corresponding account in the form of token on the blockchain. The token is associated with metadata of NFT assets. The metadata includes related information describing content of the NFT, including but not limited to a storage location, historical data, or the like.

(3) Decentralized identity (DID), or referred to as a decentralized digital identity:

It is essentially a set of blockchain technology-based digital identity and credential signature verification protocols, and includes two core components: decentralized identifiers DIDs and verifiable credentials (VCs). An infrastructure of the decentralized digital identity can be deployed in a decentralized environment (such as a blockchain network) instead of being deployed in a centralized environment controlled by a single organization or an alliance organization. In this way, true autonomy of an identity can be implemented. The identity here may refer to an identity of a human being, an organization, or an object. In other words, an object (or referred to as an entity) having the decentralized digital identity is not limited to a human being or an animal having life activities, but can also be other items without life activities, or the like.

The decentralized digital identifiers (DIDs) are identifiers composed of strings (which are a string of data composed of characters, such as ahd21db23XX), and configured for representing a digital identity of a target object and can achieve global uniqueness without registering a mechanism. An object can usually have a plurality of digital identities. Each digital identity is assigned a unique DID value and an asymmetric key (that is, different public keys and private keys) associated with the digital identity. There is no associated information between different digital identities, so that the aggregation of owner identity information is effectively avoided. The verifiable credentials VCs are declaration files formed by the credential issuer endorsing attributes of an entity (such as a target object). The verifiable credentials may be issued by an identity owner (such as an individual or organization) or by another credential issuer. For example, the digital identity is issued by a credential issuer. Specifically, the digital identity may be issued by an identity endorser (the certificate issuer) who endorses and signs attribute information of an identity owner according to a request of the identity owner. Attribute information of the identity owners is different depending on different identity owners and different credential generation scenarios, and verifiable credentials generated based on the attribute information are also different. For example, in an educational certification scenario, the identity endorser may be a node used by a school. The verifiable credentials may be school's endorsement of attribute information (such as age information, major information, grade information, and school information) of a student to generate a diploma and the like of the student.

According to the foregoing related descriptions to the blockchain network, the digital entity, and the decentralized digital identity, embodiments of the present disclosure provide a digital entity processing solution. In this solution, expression of identities of the NFT, an NFT issuer (that is, an object that mints the NFT), an NFT holder (that is, an object having permission to operate the digital entity, which may be the same as or different from the NFT issuer), and another object by the DID digital identity is supported. A DID protocol is user to express and describe the NFT and a related participant, so that blockchain digital assets have two-layer technical protocol attributes of the DID and the NFT. This solution combines a DID protocol specification and an NFT protocol specification, can implement all technical capabilities of the NFT according to the DID protocol specification, including functions such as minting, publishing, and transfer, and is a new type of NFT implementation solution.

A general principle of this solution may include the following. When a target object has a need to perform a target operation (such as minting or transfer) on the digital entity, the target object can initiate an operation request for the digital entity. In response to the operation request, a digital identifier of the target object is obtained. The digital identifier is configured for uniquely identifying an identity of the target object, such as an identity ID, a number, or a nickname. Then, an entity operation credential can be generated based on the digital identifier of the target object and operation information of the target operation carried in the operation request. The entity operation credential is configured for indicating the target operation that the target object wants to perform for the digital entity. When the target object confirms that the target operation indicated by the entity operation credential is performed on the digital entity, statement data signed by first signature data (such as a private key) of the target object can be obtained. Further, when second signature data (such as a public key) of the target object is used to perform signature verification on the statement data successfully, the target operation is performed on the digital entity to achieve a function of performing an operation for the digital entity.

In conclusion, in embodiments of the present disclosure, a DID protocol is introduced into a conventional NFT operation implementation process, and advantages of the DID protocol and an NFT protocol can be combined, so that the digital entity processing solution provided in the embodiments of the present disclosure includes, but is not limited to the following advantages. \textcircled{1} Because decentralized digital identifiers and verifiable credentials have advantages of international standards, strong expressive capabilities, readability, and security, when identities of an NFT and a related participant (which is an entity such as the NFT, an NFT issuer, or an NFT holder) are expressed and described by using the DID protocol, descriptions of the NFT are rich and complete, In addition, the decentralized digital identifiers and verifiable credentials have has good technical scalability, so that expression and readability of the NFT are optimized. \textcircled{2} A DID is used to implement the NFT and interconnection as well as up-down support of the two-layer protocols. In this way, in addition to following its own protocol specifications, the NFT can also complete protocol interoperability by using a protocol of the DID layer, and has better protocol compatibility and interoperability portability. The NFT supports more protocol capabilities by using routing and cross-chain capabilities of the DID. This improves interoperability, portability, and scenario expansion capabilities of a digital asset layer, thereby facilitate implementing more scenarios. \textcircled{3} The verifiable credentials under the DID protocol also have the capability for third-party signature and signature verification. This means that NFT implementation solutions based on the DID have better supervision capabilities. For example, minting and transfer certificates of the DID can be signed and performed signature verification by a third-party authority. This is not available based on a single-layer NFT protocol. More regulatory functions can be applied to the NFT by high readability and traceability of the decentralized digital identifiers DIDs, so that the embodiments of the present disclosure can adapt to an NFT scenario having a regulatory requirement, such as a consortium blockchain-based NFT implementation scenario.

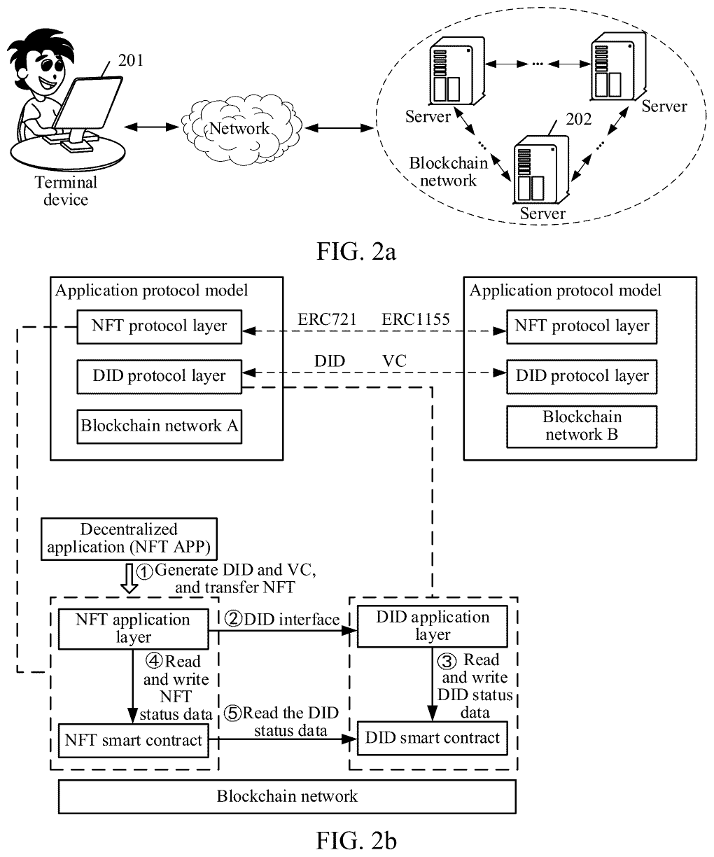

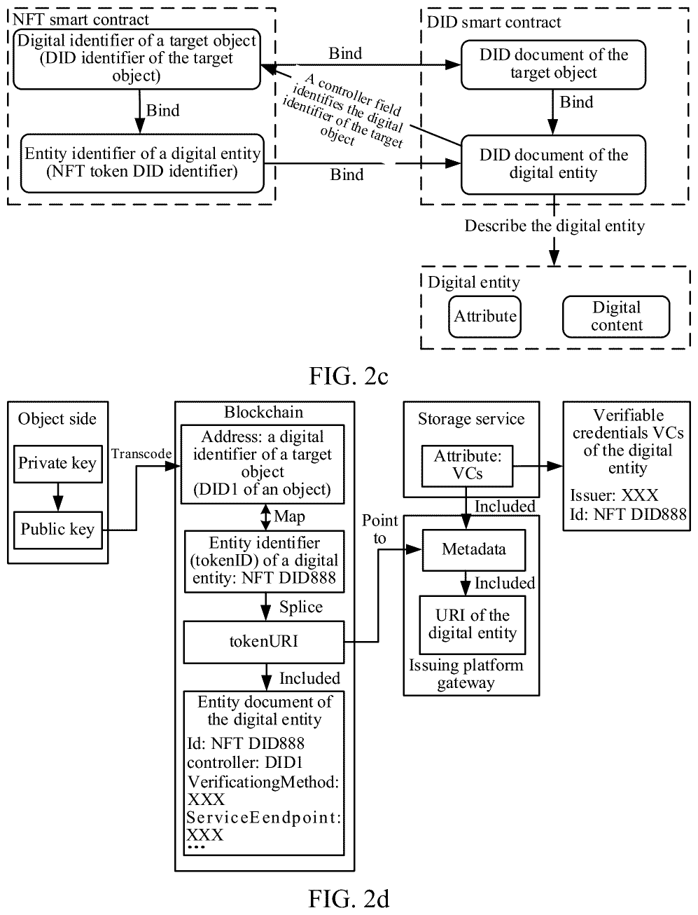

To better understand the digital entity processing method provided in embodiments of the present disclosure, the following provides, with reference to FIG. 2a, an exemplary digital entity processing system in which this method can be applied. As shown in FIG. 2a, the digital entity processing system includes a terminal device 201 and a server 202. Quantities and types of the terminal device 201 and the server 202 are not limited in embodiments of the present disclosure. The following describes an electronic device related to the digital entity processing system.

(1) The terminal device 201 may refer to a device on which a decentralized application (the aforementioned decentralized application DApp) is deployed. The terminal device 201 may be a blockchain node device belonging to a blockchain network, or may be a device that is independent of the blockchain network, while a blockchain in the blockchain network provides trusted data to the DApp. The terminal device 201 includes, but is not limited to a smartphone (such as an Android mobile phone or an iOS mobile phone), a tablet computer, a portable personal computer, a mobile Internet device (MID for short), a smart TV, an in-vehicle device, a headset device, or the like.

The decentralized application of a digital entity deployed in the terminal device 201 is an application client that supports a target object to send an operation request about the digital entity. A running mode of the decentralized application is not limited in embodiments of the present disclosure. For example, the decentralized application is a client deployed on the terminal device 201 via an installation package. For another example, the decentralized application can run on the terminal device in the form of an online application. For still another example, the decentralized application can run in the form of small program among other applications deployed in the terminal device.

The decentralized application deployed in the terminal device is used to achieve, but is not limited to the following functions.

\textcircled{1} A public key and a private key of the target object are generated and saved. The public key and the private key may include a public key and a private key. The public key and the private key are a pair of keys. If an encipherer uses the private key of the target object to encrypt data, a decipherer can only obtain the decrypted data by decrypting the encrypted data using the public key corresponding to the private key of the target object. In other words, the decentralized application has the capability to generate the public key and the private key for the target object, and save the public key and private key for the target object after generating the public key and the private key of the target object.

\textcircled{2} A digital identifier of the target object is received and saved. The digital identifier here refers to the aforementioned decentralized digital identifiers (DIDs), and no distinction is described herein. In other words, the decentralized application deployed in the terminal device can also receive the digital identifier of the target object and achieve a function of saving the received digital identifier.

\textcircled{3} An entity operation credential of the target object is generated and saved. The entity operation credential here may refer to the aforementioned verifiable credentials VCs, and no distinction is described herein. The verifiable credentials VCs are different depending on different operations that the target object wants to perform for the digital entity. For example, in a scenario in which the target object needs to mint a digital entity, the minting a digital entity may be simply understood as a process of generating the digital entity and uploading the digital entity on a blockchain. Verifiable credentials generated in this case are configured for indicating that the digital entity is requested to be performed a minting operation, that is, the digital entity is requested to be minted. For another example, in a scenario in which the target object wants to transfer the digital entity, the transferring the digital entity may be simply understood as transferring operation permission of the digital entity from one object to another object, verifiable credentials generated in this case are configured for indicating that the digital entity is requested to be performed a transfer operation, that is, the digital entity is requested to be transferred.

(2) The server 202 may refer to a device having a function of implementing an interactive operation (which is an operation such as minting or transfer) corresponding to the digital entity. The server 202 is a blockchain node device belonging to the blockchain network. A DID-based NFT protocol model innovatively provided in embodiments of the present disclosure is deployed in the server 202. The DID-based NFT protocol model can be alternatively referred to as a blockchain application protocol model. The server can specifically implement the interactive operation corresponding to the digital entity by using the blockchain application protocol model. Refer to FIG. 2b. The blockchain application protocol model includes an NFT protocol layer, a DID protocol layer, and a blockchain network from top to bottom. Each protocol layer may include a corresponding application layer and a corresponding smart contract. For example, the NFT protocol layer includes an NFT application layer and an NFT smart contract. Similarly, the DID protocol layer includes a DID application layer and a DID smart contract. The following separately describes functions of the application layer and the smart contract in the protocol layer with reference to FIG. 2b.

The NFT protocol layer includes the NFT application layer and the NFT smart contract. The following separately describes functions of the NFT application layer and the NFT smart contract briefly.

\textcircled{1} The NET application layer can be configured to process an operation request sent by a terminal device. For example, the operation request may include an entity digital identifier registration request. In this case, the NFT application layer can uniformly process an entity DID identifier registration request on an NFT application end side (such as an NFT wallet in the terminal device). Specifically, in response to the DID identifier registration request, the DID protocol layer, such as the DID application layer or the DID smart contract, is invoked to complete generation and registration of a digital identifier of a target object. In addition, the registered digital identifier is also bound to a public key of the target object. In this way, the public key bound to the digital identifier and an asymmetric encryption technology can be used to verify whether an operator on an NFT application end is the target object of the corresponding digital identifier, so that identity verification of the target object is implemented, thereby improving security of data processing.

After registering and obtaining the digital identifier of the target object, the NFT application layer can also assign the digital identifier of the target object to the terminal device (that is, the NFT application end). In this way, the target object can initiate, based on the digital identifier, an operation request (or referred to as an NFT operation request) related to a digital entity through the NFT application end (that is, the aforementioned DApp), to enable the NFT application layer to process the NFT operation request, such as minting and transfer, sent by the NFT application end. For example, in an NFT minting scenario, the NFT application layer can invoke the DID application layer to directly generate a DID identifier (to facilitate distinction between a DID identifier of the target object and a DID identifier of the digital entity, where the DID identifier of a digital entity is referred to as an entity identifier) corresponding to a token (that is, the digital entity) in the DID smart contract. Alternatively, the NFT application layer can use the NFT smart contract to indirectly generate the DID identifier corresponding to the token in the DID smart contract. For another example, in an NFT transfer scenario, the NFT application layer can invoke the DID application layer to directly verify verifiable credentials VCs corresponding to the target object. Alternatively, the NFT application layer can use the NFT smart contract to indirectly verify the verifiable credentials VCs corresponding to the target object, to check whether the target object has operation permission to operate the digital entity, for example, to detect whether the target object has transfer permission to transfer the digital entity, or to detect whether the target object has minting permission to mint the digital entity.

\textcircled{2} The NFT smart contract is configured for processing and manage data related to the digital entity. For example, the NFT smart contract stores, between the digital identifier of the target object and the entity identifier of the digital entity, a binding relationship configured for anchoring an object to which the digital entity belongs. For example, if there is a binding relationship (or referred to as a binding mapping relationship) between an entity identifier of a digital entity A and a digital identifier of a target object a, and the binding relationship anchors a holding object of the digital entity A as the target object a, a holder of the digital entity A is determined as the target object A according to the binding relationship. To improve credibility of the smart contract, the NFT smart contract can directly invoke the DID smart contract to generate the DID identifier of the digital entity, and directly invoke the DID smart contract to verify the verifiable credentials VCs. In addition, the NFT smart contract performs a corresponding target operation on the digital entity after successful verification of the verifiable credentials (VCs). For example, the binding relationship between the digital identifier of the target object and the entity identifier of the digital entity can be modified to complete transfer of the digital entity.

Similar to the NFT protocol layer, the DID protocol layer includes the DID application layer and the DID smart contract. The following separately describes functions of the DID application layer and the DID smart contract briefly.

\textcircled{1} The DID application layer can be configured to process an operation request (such as creating a digital identifier or verifying a credential) sent by the NFT application layer located on the DID application layer in the protocol model, and configured to connect downward to the DID smart contract in the protocol model to read and write DID status data. In other words, the DID application layer, as an intermediate layer, can enter the DID smart contract provided that all service logic that needs to be processed in the DID smart contract can be used as a service entrance by using the DID application layer.

The DID status data includes, but is not limited to, data included in a DID document of the target object and data included in a DID document of the digital entity. The DID smart contract can parse the digital identifier of the target object to obtain the DID document of the target object. Similarly, the DID smart contract can parse the entity identifier of the digital entity to obtain the DID document of the digital entity. In other words, each DID identifier corresponds to own DID document, and a DID document of any entity is configured for describing and expressing content of the entity. For example, if the entity is the target object, document data included in the DID document of the target object may include information related to the target object, including but not limited to a public key and attribute information (such as age, nickname, gender, or registration time) of the target object. For another example, if the entity is the digital entity, document data included in the DID document of the digital entity may include information related to the digital entity, including but not limited to metadata such as attribute information (such as form information and minting time of the digital entity) and digital content (such as element information included in the digital entity) of the digital entity, configured for expressing all or part of information of an NFT entity (that is, the digital entity).

\textcircled{2} The DID smart contract can be configured for processing and managing data related to the DID. For example, the DID smart contract stores all status data of the DID, including DID documents of the target object and the digital entity, specifically the document data included in the DID documents. In different application scenarios relating to the digital entity (such as a scenario of minting the digital entity or a scenario of transferring the digital entity), the DID status data in the DID smart contract can be read and written by using the DID application layer and the NFT smart contract. In addition, the DID smart contract further includes a contract interface for verifying the verifiable credentials. The DID smart contract can call the contract interface to verify whether a signed verifiable credential is signed by a corresponding DID entity (such as a target object signed with a private key).

For a protocol mapping relationship between the NFT smart contract and the DID smart contract provided in embodiments of the present disclosure, refer to FIG. 2c. As shown in FIG. 2c, the NFT smart contract stores the digital identifier of the target object (the DID identifier of the target object) and the entity identifier of the digital entity (an NFT token DID identifier). In addition, the NFT smart contract further stores a binding mapping relationship between the digital identifier of the target object and the entity identifier of the digital entity. A holder of the digital entity can be determined as the target object according to the binding mapping relationship. The DID smart contract stores a DID document of the target object. The DID document of the target object is obtained by parsing the digital identifier of the target object. In other words, there is a binding relationship between the digital identifier of the target object and the DID document of the target object. Similarly, the DID smart contract further stores a DID document of the digital entity. The DID document of the digital entity is obtained by parsing the entity identifier of the digital entity. In other words, there is a binding relationship between the entity identifier of the digital entity and the DID document of the digital entity. Further, the DID document of the digital entity in the DID smart contract further includes a controller field. The controller field can identify the target object to which the digital entity belongs. Specifically, the digital identifier of the target object is assigned to the controller field, representing that an owner of the digital entity is the target object. In other words, the target object has operation permission to perform an interactive operation on the digital entity.

To implement the digital entity processing method jointly completed by the two protocols, the DID protocol and the NFT protocol need to be designed to determine a mapping relationship (or referred to as a correspondence) of fields on both sides of the DID protocol and the NFT protocol. For example, a value is assigned to some fields in the protocol, so that content of a protocol of another party can be identified based on a specific field in a protocol of any party. For example, after a DID document is obtained, it can be determined that the DID document is an entity document of a digital entity based on a field in the DID document.

For a schematic diagram of a DID protocol-based NFT protocol design provided in an embodiment of the present disclosure, refer to FIG. 2d. The following briefly describes, with reference to FIG. 2d, some exemplary protocol designs provided in embodiments of the present disclosure, and does not constitute a limitation on the embodiments of the present disclosure. The DID-based NFT protocol design can define, but is not limited to, the following specifications.

\textcircled{1} An object side (that is, a terminal device side used by a target object) can generate first signature data and second signature data of the target object. For example, an asymmetric cryptography algorithm-based public key and private key are generated based on the object side. The first signature data is the public key, and the second signature data is the private key. In addition, an application protocol model (that is, the aforementioned blockchain application protocol model) can transcode the public key of the target object into a digital identifier of the target object according to DID specifications, and register the digital identifier of the target object on a blockchain.

\textcircled{2} It is supported that an entity identifier can be created for a minted digital entity. In other words, the digital entity generated by minting also has a DID identifier. The DID identifier corresponds to a DID document (that is, the aforementioned entity document) for describing and expressing digital entity content in an NFT protocol standard.

\textcircled{3} A service field in the DID document corresponding to the digital entity can be assigned as the entity identifier of the digital entity, so that metadata of the digital entity can be accessed based on the entity identifier. In other words, the metadata of the digital entity can be accessed based on the field. For example, if the digital entity is a digital image, a uniform resource identifier (URI) of the digital entity can be assigned to the service field in the DID document corresponding to the digital entity, so that the metadata of the digital entity can be accessed based on the URI of the digital entity.

The metadata of the digital entity can be stored in a digital entity issuing platform gateway. Metadata stored in the digital entity issuing platform gateway can be accessed based on the entity identifier of the digital entity. The metadata includes attribute information of the digital entity NFT. The attribute information can be saved in the form of JSON in various storage services such as decentralized storage or object storage. The metadata further stores an access path to a visual presentation file (such as a digital image) of the NFT.

\textcircled{4} A controller field in the DID document corresponding to the digital entity can be bound to the digital identifier of the target object to represent a binding relationship between the entity identifier of the digital entity and the digital identifier of the target object. In other words, an owner of the digital entity is the target object. In addition, status data (that is, data included in the DID document) of the DID document can be persisted on the blockchain to ensure that the data cannot be tampered with.

\textcircled{5} If an interactive operation that the target object wants to perform for the digital entity includes an operation of transferring the digital entity, in a scenario in which a holder (such as the target object) of the digital entity transfers the digital entity, transfer effective duration can be set for verifiable credentials (or referred to as entity transfer credentials) issued by the holder of the digital entity. In this way, a claim statement of an entity operation credential needs to include a digital identifier of a reference object of a to-be-received digital entity and an entity identifier of the digital entity. In addition, the entity transfer credentials need to be signed by the target object (that is, the holder). Certainly, the claim statement may further include, according to a service requirement, another transfer condition needed for customizing. Specifically, information configured in the claim statement can be flexibly configured and extended according to an application scenario. This is not limited herein.

According to the foregoing related descriptions of the blockchain application protocol model, a difference of an underlying blockchain network can be removed by using the DID protocol layer on different blockchain networks (a blockchain network A and a blockchain network B as shown in FIG. 2b). The NFT protocol layer is built above the DID protocol layer. In other words, the NFT protocol layer can invoke the lower DID protocol layer. In this way, NFT assets can implement interoperability between different smart contracts or different blockchain networks based on decentralized identifiers (DIDs) and verifiable credentials (VCs) protocols of the DID protocol. In addition, standard blockchain identity layer protocol support can be provided for the NFT protocol to improve account and asset security as well as an autonomous control capability of an NFT implementation solution with a consortium blockchain as a bottom layer.

In embodiments of the present disclosure, integration of functions of the application layer into the smart contract is further supported, so that the NFT protocol layer and the DID protocol layer in the blockchain application protocol model can only include the smart contract without additional application layers. In addition, in addition to the terminal device 201 and the server 202, the digital entity processing system related to embodiments of the present disclosure may alternatively include only the server. In this implementation, a decentralized application can be deployed in the server. A type and a quantity of devices included in the digital entity processing system are not limited in embodiments of the present disclosure. In addition, when embodiments of the present disclosure are applied to a specific entity or technology, such as obtaining a digital identifier of a target object, permission or consent of the target object needs to be obtained in this case. In addition, collection, usage, and processing of related data need to comply with the relevant laws, regulations, and standards of the relevant countries and regions. For example, an interactive operation for the digital entity needs to comply with the relevant laws, regulations, and standards of the relevant countries and regions.

According to the digital entity processing solution described above, embodiments of the present disclosure provide a more detailed digital entity processing method. The following describes, with reference to the accompanying drawings, the processing method provided in the embodiments of the present disclosure in detail.

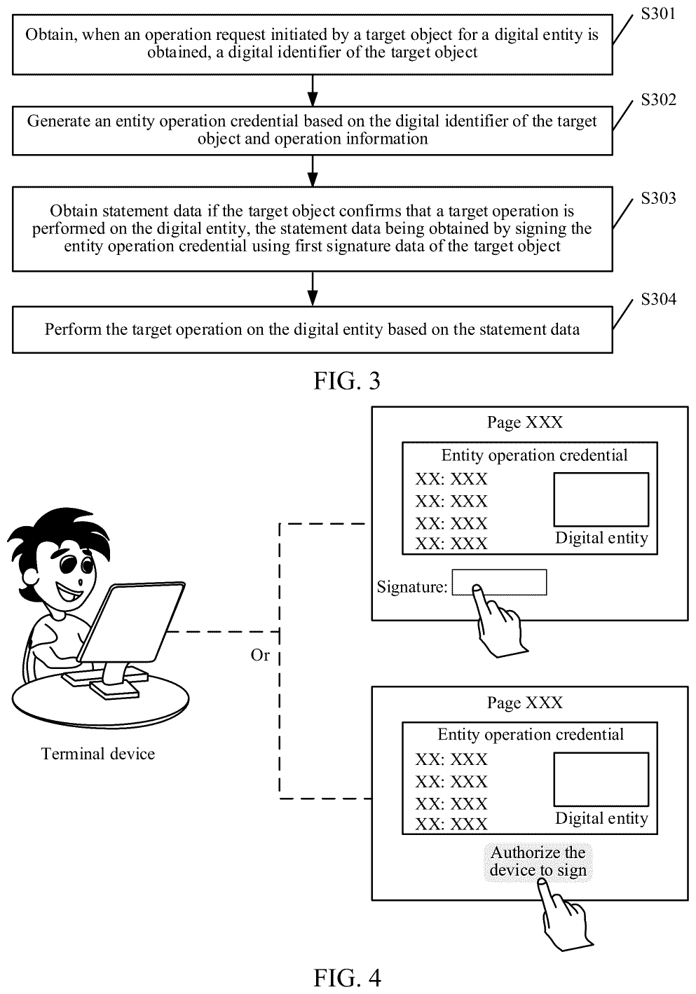

FIG. 3 is a schematic flowchart of a digital entity processing method according to an exemplary embodiment of the present disclosure. The digital entity processing method may be performed by an electronic device, for example, by the server in the system shown in FIG. 2a. The processing method may include, but is not limited to, operation S301 to operation S304.

S301: Obtain, when an operation request initiated by a target object for a digital entity is obtained, a digital identifier of the target object.

In a specific implementation, when the target object has a need to perform a target operation for the digital entity, the target object initiates an operation request by using an electronic device owned by the target object. The operation request carries operation information of the target operation that the target object requests to perform for the digital entity. The operation information is information configured for describing the target operation requested to be performed for the digital entity. The digital identifier of the target object is then obtained in response to the operation request. Operation information of target operations is different depending on different target operations. For example, the target operation for the digital entity includes, but is not limited to minting operation, transfer operation, or the like. When the target operation is the minting operation, the operation information of the target operation includes at least entity minting information (such as element information of various elements included in the digital entity) required for minting the digital entity, a digital identifier of an owner of a minted digital entity, and the like. When the target operation is the transfer operation, the operation information of the target operation includes at least a digital identifier of a reference object of a to-be-received digital entity, a digital identifier of a holder of the digital entity before transfer, and the like.

It can be learned from the foregoing descriptions that a terminal device owned by the target object and an execution entity server of embodiments of the present disclosure may be the same electronic device or different electronic devices. Depending on different systems related to the embodiments of the present disclosure, an electronic device that generates the operation request may be a terminal device or a server, and may be specifically an electronic device that has a function to invoke a third-party authority to generate verifiable credentials. In one embodiment, the terminal device and the server are different electronic devices. The target object can perform an initiation operation on the terminal device owned by the target object. In this way, the terminal device can generate an operation request based on the detected initiation operation. In addition, the terminal device sends the operation request to the server while the server invokes the third-party authority to generate an entity operation credential, so that the server can perform, in response to the operation request, an operation to obtain the digital identifier of the target object. Certainly, if the terminal device has the capability to invoke the third-party authority to generate the entity operation credential, the terminal device can directly respond to, after generating the operation request, the operation request to generate the entity operation credential without sending the operation request to the server. In one embodiment, the terminal device and the server are the same electronic device. The target object can perform an initiation operation in the server for the digital entity. In this way, the server can generate an operation request based on the detected initiation operation, and perform, in response to the operation request, an operation of obtaining the digital identifier of the target object. Whether the electronic device used in embodiments of the present disclosure to generate the operation request is a terminal device or a server is not limited.

Depending on different target operations that the target object wants to perform for the digital entity, specific implementation processes of the target object performing the initiation operation are also different. For example, if the target operation that the target object needs to perform for the digital entity is the minting operation, the initiation operation that the target object performs by using the electronic device may include: entering the entity minting information required for minting the digital entity in a display screen (or such as a display for short) provided by the electronic device. For another example, if the target operation that the target object wants to perform for the digital entity is the transfer operation, the initiation operation that the target object performs by using the electronic device may include: entering an entity identifier of a to-be-transferred digital entity, a digital identifier of a reference object of a to-be-received digital entity, and the like in the display screen provided by the electronic device. The above are merely exemplary processes of two types of initiation operations provided in embodiments of the present disclosure. When the target operation is another operation, the initiation operation performed by the target object may also change correspondingly. This is not limited in embodiments of the present disclosure.

Further, after the operation request initiated by the target object for the digital entity is received, an implementation process of obtaining the digital identifier of the target object in response to the operation request may include: obtaining the digital identifier of the target object from storage space, or generating the digital identifier of the target object and registering the digital identifier on a blockchain. In other words, if the digital identifier of the target object is generated before the operation request of the target object for the digital entity is received, the digital identifier of the target object can be obtained directly from the storage space when the operation request is received. Specifically, the digital identifier of the target object is obtained from a list that is in the storage space and that is configured for storing digital identifiers. The digital identifier of the storage space may be stored in the storage space after the digital identifier is generated by a DID smart contract. Alternatively, the digital identifier of the storage space may be decentralized to the storage space when another blockchain node registers the digital identifier of the target object on the blockchain. On the contrary, if the digital identifier of the target object is not generated and registered before the operation request of the target object for the digital entity is received, the digital identifier of the target object can be generated and registered based on the operation request to obtain the digital identifier of target object.

The digital identifier of the target object may be an identifier that is generated based on object information of the target object and can uniquely identify the target object. The object information of the target object may include, but is not limited to, attribute information (such as a nickname and an ID number) of the target object, a public key of the target object, or the like. Specifically, a generation process of the digital identifier of the target object may include: first obtaining the object information of the target object, then converting the object information into the digital identifier of the target object. For example, if the object information of the target object includes the public key of the target object, the public key can be transcoded into the digital identifier according to DID specifications, and the generated digital identifier is registered on the blockchain to obtain the digital identifier of the target object.

A process of generating the digital identifier of the target object is different depending on different generating time of the digital identifier of the target object (for example, generating before or after the operation request is received).

In one embodiment, it is assumed that the digital identifier of the target object is generated before the operation request initiated by the target object for the digital entity is received, the generation process of the digital identifier of the target object may include: When the target object has a need to register an identifier, the target object can initiate an identifier registration request. The identifier registration request carries the object information of the target object. Further, the object information is converted into the digital identifier of the target object in response to the identifier registration request. Then, the digital identifier of the target object is registered on the blockchain, so that each blockchain node in a blockchain network can be synchronized to the digital identifier of the target object, to implement decentralized storage of the digital identifier of the target object. In this way, any blockchain node in a subsequent blockchain network can be synchronized directly from the blockchain when the blockchain node has a need to obtain the digital identifier of the target object. The manner of registering the digital identifier of the target object on the blockchain in advance can improve speed and efficiency of performing a related operation for the digital entity to some extent subsequently.

In another implementation, it is assumed that the digital identifier of the target object is generated after the operation request initiated by the target object for the digital entity is received, the generation process of the digital identifier of the target object may include: When the operation request is received and no digital identifier of the target object is detected, an information obtaining request is returned (for example, the information obtaining request is returned to the terminal device owned by target object). The information obtaining request is configured for requesting to obtain the object information of the target object. The object information of the target object returned in response to the information obtaining request is received, and the object information is converted into the digital identifier of the target object.

The above are merely two exemplary processes of generating the digital identifier of the target object. In actual application, the generation process of the digital identifier of the target object may change. This is not limited in embodiments of the present disclosure.

S302: Generate an entity operation credential based on the digital identifier of the target object and the operation information.

S303: Obtain statement data if the target object confirms that the target operation is performed on the digital entity, the statement data being obtained by signing the entity operation credential using first signature data of the target object.

In operation S302 and operation S303, after the target operation that the target object wants to perform for the digital entity is determined based on the operation request initiated by the target object for the digital entity, the entity operation credential can be generated based on the digital identifier of the target object and the operation information of the target operation. The entity operation credential is similar to a digital certificate, is configured for indicating a request to perform the target operation for the digital entity, is further configured for indicating that a requester of the target operation is the target object, and can be used as record data for the target object to initiate the operation request for the digital entity. The entity operation credential may be generated by the terminal device owned by the target object. In this case, the terminal device can generate the entity operation credential based on the operation information of the target operation requested by the operation request and the digital identifier of the target object, and transmit the entity operation credential to the server. Alternatively, the entity operation credential can also be generated by the server. In this case, the server can generate the entity operation credential based on the obtained digital identifier of the target object and the operation information of the target operation in a case of obtaining the operation request.

The electronic device that generates the entity operation credential is not limited in embodiments of the present disclosure. For example, if a decentralized application is deployed on the server, the target object can directly perform an operation on the server. In this case, there is no need to include the terminal device in a processing system. In this way, the entity operation credential is generated by the server. For ease of description, an example in which a terminal device deployed with the decentralized application (DApp) generates the entity operation credential is described subsequently.

Further, the target object can obtain the entity operation credential. For example, the server returns the entity operation credential to the terminal device owned by the target object, so that the target object obtains the entity operation credential by the terminal device. Alternatively, the terminal device generates and outputs the entity operation credential, so that the target object can view the entity operation credential. After obtaining the entity operation credential, the target object can view information included in the entity operation credential. If the target object confirms that a target operation indicated by the entity operation credential is performed on the digital entity, the first signature data of the target object can be used to sign the entity operation credential. For example, the first signature data is used to digitally sign the entity operation credential to generate the statement data. The first signature data of the target object here is a private key of the target object. Finally, the target operation is performed on the digital entity based on the statement data signed by the target object. For details, refer to a specific implementation process shown in operation S304. In the foregoing implementation process, only when target object confirms that the target operation is performed on the digital entity, the first signature data of the target object is used to sign the entity operation credential. This represents that the target operation is performed on the digital entity based on permission of the target object, so that security of operating the digital entity can be ensured.

When the entity operation credential is generated by the terminal device deployed with the decentralized application (DApp), the target object can use, by using the decentralized application, self-owned first signature data (such as a private key) to sign the entity operation credential to generate the statement data. Further, the statement data is sent to the server, so that the server can perform the target operation on the digital entity based on the statement data. In one embodiment, the target object can directly use the self-owned first signature data to sign the entity operation credential to generate the statement data. In one embodiment, the target object can authorize the terminal device to obtain the first signature data of the target object, and use the first signature data to sign the entity operation credential to generate the statement data.

When the entity operation credential is generated by the server, such as a server deployed with the decentralized application, the server can obtain the statement data in any one of the following manners depending on whether the server and the terminal device owned by the target object are the same electronic device or different electronic devices.

In one embodiment, the terminal device and the server are different electronic devices. In one embodiment, the server can transmit the entity operation credential to the terminal device owned by the target object, and then the terminal device returns the statement data obtained by the target object using the first signature data to sign the entity operation credential. In a specific implementation, after generating the entity operation credential based on the digital identifier of the target object and the operation information of the target operation, the server can transmit the entity operation credential to the target object, specifically to the terminal device owned by the target object, to enable the terminal device to display the entity operation credential on a display screen, as shown in FIG. 4. The target object can intuitively view the information included in the entity operation credential on the display screen. When the target object confirms that the target operation indicated by the entity operation credential is performed on the digital entity, the target object directly uses the first signature data of the target object or authorizes the terminal device to use the first signature data of the target object to sign the entity operation credential to obtain the statement data. The terminal device then returns the statement data obtained by signing to the server. In this way, the server can receive the statement data directly from the terminal device.

In one embodiment, the server can generate an authorization request based on the entity operation credential. The authorization request carries the entity operation credential. The authorization request is configured for requesting the target object to authorize the server to sign the entity operation credential. In addition, the authorization request is sent to the terminal device. The terminal device outputs the entity operation credential in response to the received authorization request. If the target object confirms that the information included in the entity operation credential is correct, and agrees to authorize the server to perform the signature processing, the terminal device returns a confirmation message indicating that the target object authorizes the server to use the first signature data to sign the entity operation credential. In this way, the server can obtain the first signature data of the target object based on the confirmation information, and sign the entity operation credential based on the first signature data to obtain the statement data.

In another implementation, the terminal device and the server are the same electronic device. In other words, the server is deployed with the decentralized application. In this implementation, the server can display the entity operation credential on the display screen. If the target object uses the first signature data to sign the entity operation credential, the signed entity operation credential is obtained in response to a signature operation performed by the target object on the entity operation credential using the first signature data, and the signed entity operation credential is used as the statement data.

As described above, the process of using the first signature data of the target object to sign the entity operation credential can be performed directly by the target object or by the server authorized by the target object. In one embodiment, the target object can use the first signature data to sign the entity operation credential to obtain the statement data. In other words, the server can obtain the signed entity operation credential in response to a signature operation performed by the target object on the entity operation credential using the first signature data of the target object. The signed entity operation credential is used as the statement data. In one embodiment, the server can further receive an authorization operation of the target object for the entity operation credential, obtain the first signature data of the target object, and sign the entity operation credential based on the first signature data of the target object to obtain the signed entity operation credential. The signed entity operation credential is used as the statement data.

According to the foregoing implement process, the target object can obtain the entity operation credential configured for indicating execution of the target operation for the digital entity, and use a DID protocol to express and describe the digital entity in the form of entity operation credential, to optimize expression and readability of the digital entity, and enable the target object to clearly understand, based on the entity operation credential, the target operation to be performed for the digital entity, thereby improving experience of the target object. In addition, through support of the DID protocol, more application functions can be applied to the digital entity to enrich an implementation scenario of the digital entity.

S304: Perform the target operation on the digital entity based on the statement data.

It can be learned from the foregoing descriptions that the statement data is obtained by signing the entity operation credential using the first signature data (such as the private key of the target object) of the target object. After obtaining the statement data, the server needs to perform signature verification processing on the statement data first. When signature verification of the statement data is successful, signature verification of an identity that wants to be performed with the target operation is successful, the target operation can be performed on the digital entity.

In a specific implementation, an implementation process of performing the target operation on the digital entity based on statement data may include: First, because the digital identifier (that is, a DID identifier) of the target object is bound with second signature data (such as the public key of the target object) of the target object, the second signature data of the target object can be obtained based on the digital identifier of the target object. Then, the second signature data of the target object is used to perform the signature verification processing on the statement data to obtain a signature verification result. Finally, when the signature verification result is that the signature verification is successful, that is, the signature verification result represents that identity verification of an operator on a terminal device side is successful, and the target operation is performed on the digital entity. On the contrary, when the signature verification result is that the signature verification is failed, it represents that identity verification of an operator on a terminal device side is failed, and the target operation is not performed on the digital entity.

In the foregoing implement process, when the first signature data of the target object is the private key of the target object, the second signature data of the target object is the public key of the target object, and the public key and the private key are different, in embodiments of the present disclosure, an asymmetric encryption technology is used to verify whether the operator of the terminal device is the target object corresponding to the digital identifier recorded in the entity operation credential, to implement verifying the identity of the operator on the terminal device side, so that transaction authorization verification before the target operation on the digital entity is implemented, thereby improving security and traceability of the digital entity. The asymmetric encryption technology can be applied to an application scenario that requires review, such as a consortium blockchain scenario.

In embodiments of the present disclosure, when an operation request initiated by a target object for a digital entity is received, an entity operation credential can be generated based on a digital identifier of the target object and operation information carried in the operation request. The entity operation credential indicates a request to perform a target operation on the digital entity, and indicates that a requester of the target operation is the target object. The entity operation credential of the digital entity is generated to intuitively inform the target object of information related to the digital entity, thereby optimizing expression and readability of the digital entity. In addition, only when the target object confirms that the target operation is performed on the digital entity, that is, the statement data (that is, the signed entity operation credential) is obtained, and signature verification of the statement data is successful, the target operation is performed on the digital entity. In the embodiments of the present disclosure, the digital identifier of the target object is used throughout an operation process of the digital entity, and the entity operation credential and the statement data are generated based on the digital identifier of the target object. In this way, during performing the target operation on the digital entity, the related operation performed for the digital entity and an execution object of the related operation are intuitively and reliably recorded, thereby improving security of the digital entity and traceability of the related operation, and further efficiently and securely implementing the target operation for the digital entity.

As described above, the digital entity processing system related to embodiments of the present disclosure may include a terminal device and a server. The terminal device is deployed with the decentralized application (DApp or NFT APP). Alternatively, the digital entity processing system may include only a server, and the server is deployed with the decentralized application. Subsequently, an example in which the digital entity processing system includes a terminal device and a server is used to mainly describe a specific implementation process of performing the target operation for the digital entity. It is not difficult to understand that an operation type of the target operation performed for the digital entity is rich. The following describes the specific implementation process of the target operation by using an example in which the target operation is an operation of minting the digital entity and an example in which the target operation is an operation of transferring the digital entity.

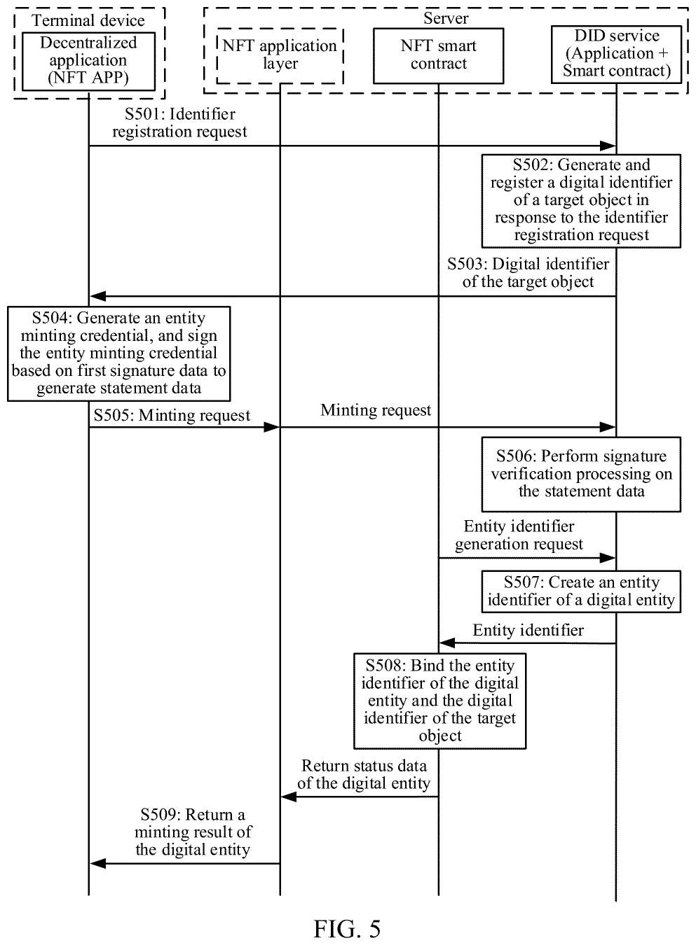

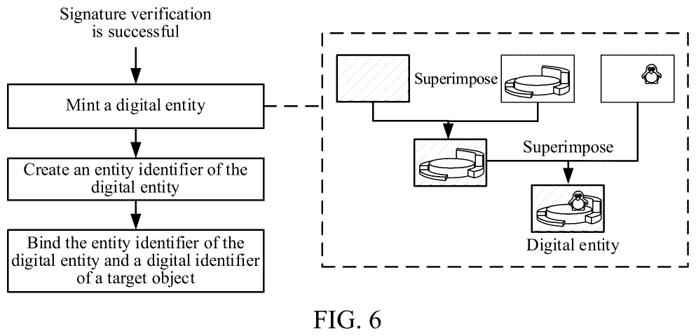

FIG. 5 is an exemplary schematic flowchart of a digital entity processing method when a target operation is an operation of minting a digital entity according to an embodiment of the present disclosure. The digital entity processing method can be jointly performed by the terminal device and the server in the system shown in FIG. 2a. The processing method may include, but is not limited to, operation S501 to operation S509.

S501: The terminal device transmits an identifier registration request to the server.

S502: The server generates and registers a digital identifier of a target object in response to the identifier registration request.

S503: The server transmits the digital identifier of the target object to the terminal device.

In operation S501 to operation S503, when the target object has a need to generate and register the digital identifier, the target object can generate an identifier registration request by the terminal device, specifically by using a decentralized application deployed in the terminal device. The terminal device then sends the identifier registration request to the server, and an NFT application layer in a blockchain application protocol model deployed in the server receives the identifier registration request. Then, the NFT application layer invokes a DID application layer, and the DID application layer invokes a DID smart contract to generate the digital identifier of the target object in response to the identifier registration request, and registers the digital identifier of the target object on a blockchain.

For a specific implementation process in which the server generates and registers the digital identifier of the target object in response to the identifier registration request, refer to the related descriptions of the specific implementation process shown in operation S301 of the embodiment shown in FIG. 3. Details are not described herein again.

S504: The terminal device generates an entity operation credential, and signs the entity operation credential based on first signature data to generate statement data.

In a scenario in which the target operation performed for the digital entity is the operation of minting the digital entity, the entity operation credential generated by the terminal device may be referred to as an entity minting credential.

In a specific implementation, if the target object has a need to mint a digital entity, the terminal device can generate an operation request in response to the need to mint a digital entity. In this case, the operation request is configured for requesting to mint the digital entity. In other words, the target operation for the digital entity is the operation of minting the digital entity. The operation information of the target operation includes at least entity minting information required for minting the digital entity. For example, if the digital entity is a digital image, entity minting information required for minting the digital image may include element information (such as an element address or an element layer) of elements that make up the digital image. Then, the terminal device generates, in response to the operation request, the entity minting credential based on the digital identifier of the target object and the operation information of the target operation. Finally, the entity minting credential is signed based on the first signature data of the target object to generate the statement data.

As described in the embodiment shown in FIG. 3 above, if the entity minting credential is generated by the server, for example, the server invokes a third-party authority to generate the entity minting credential, then the terminal device can send the operation request to the server, and the server generates the entity minting credential in response to the operation request. A specific implementation process in which the server generates the entity minting credential is not limited herein.

S505: The terminal device generates a minting request based on the entity operation credential and sends the minting request to the server. The minting request carries the signed entity operation credential (that is, the statement data).

S506: The server performs signature verification processing on the statement data in response to the minting request.

In operation S505 and operation S506, when the server obtains the minting request, the server also obtains the statement data carried by the minting request, then the server can perform the signature verification processing on the statement data based on the digital identifier of the target object. Specifically, the digital identifier of the target object is bound with a public key of the target object, so that the server can obtain the public key of the target object, and perform the signature verification processing on the statement data based on the public key of the target object to obtain a signature verification result.

S507: The server creates the entity identifier of the digital entity if the signature verification is successful.

S508: The server binds the entity identifier of the digital entity and the digital identifier of the target object.

In operation S507 and operation S508, when the signature verification of the statement data is successful based on second signature data of the target object, it represents that identity verification of an entity on a terminal device side is successful. In other words, the entity on the terminal device side is the target object that uses the first signature data to digitally sign the entity minting credential, and can perform the target operation for the digital entity.

A specific implementation process of performing the target operation on the digital entity, where the target operation is the operation of minting the digital entity, can be shown in FIG. 6. The specific process may include: First, the digital entity is minted based on the entity minting information required for minting the digital entity. For example, if the digital entity is a digital image, the entity minting information required for minting the digital entity are element images belonging to different layer levels, then the element images are superimposed in descending order (or ascending order) of layer levels to mint the digital image. Then the server can create an entity identifier for the minted digital entity based on the DID smart contract in the blockchain application protocol model deployed in the server. The entity identifier is a DID identifier of a digital entity NFT for uniquely identifying the digital entity. Finally, the entity identifier of the digital entity and the digital identifier of the target object can be bound, so that there is a mapping binding relationship between the entity identifier of the digital entity and the digital identifier of the target object. The mapping binding relationship can be stored in an NFT protocol layer in the blockchain application protocol model, specifically in an NFT smart contract in the NFT protocol layer. In this way, an owner of the digital entity can be determined as the target object according to the mapping binding relationship. In other words, the target object is the only object that has operation permission to operate the digital entity.

A specific implementation process of binding the digital entity and the target object may include: establishing a first mapping binding relationship based on the digital identifier of the target object and the entity identifier of the digital entity, the first mapping binding relationship may referring to the foregoing mapping binding relationship, and the first mapping binding relationship being configured for indicating that a holder of the digital entity is the target object; and storing the first mapping binding relationship in a smart contract corresponding to the digital entity, that is, the NFT smart contract, to implement the binding of the digital entity and the target object.

S509: The server returns a minting result for the digital entity to the terminal device.

In a specific implementation, the server can return the minting result for the digital entity to the terminal device. The minting result for the digital entity here may include the minted digital entity (such as a digital image), a result of uploading the digital entity on a blockchain (such as uploading the digital entity on a blockchain successfully), and the like. Specific content included in the minting result is not limited in embodiments of the present disclosure.

In embodiments of the present disclosure, when an operation request initiated by a target object for a digital entity is received, an entity operation credential can be generated based on a digital identifier of the target object and operation information carried in the operation request. In addition, the entity operation credential indicates a request to perform a target operation for the digital entity, and indicates that a requester of the target operation is the target object. The entity operation credential of the digital entity is generated to intuitively inform the target object of information related to the digital entity, thereby optimizing expression and readability of the digital entity. In addition, only when the target object confirms that the target operation is performed on the digital entity, that is, the statement data (that is, the signed entity operation credential) is obtained, and signature verification of the statement data is successful, the target operation is performed on the digital entity. In the embodiments of the present disclosure, the digital identifier of the target object is used throughout an operation process of the digital entity, and the entity operation credential and the statement data are generated based on the digital identifier of the target object. In this way, during performing the target operation on the digital entity, the related operation performed for the digital entity and an execution object of the related operation are intuitively and reliably recorded, thereby improving security of the digital entity and traceability of the related operation, and further efficiently and securely implementing the target operation for the digital entity, such as the operation of minting the digital entity.

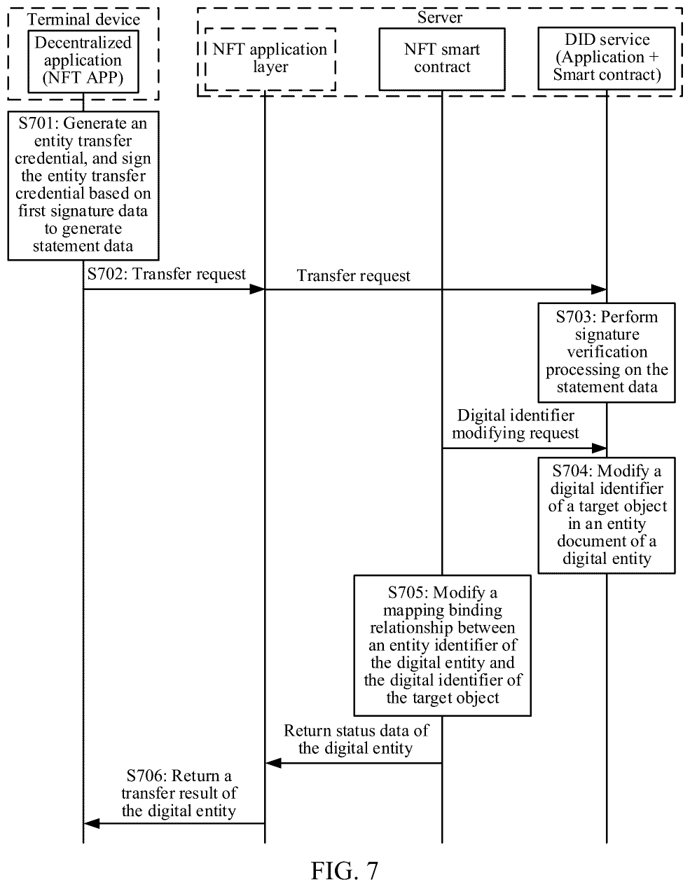

FIG. 7 is an exemplary schematic flowchart of a digital entity processing method when a target operation is an operation of transferring a digital entity according to an embodiment of the present disclosure. The digital entity processing method can be jointly performed by the terminal device and the server in the system shown in FIG. 2a. The processing method may include, but is not limited to, operation S701 to operation S706.

S701: The terminal device generates an entity operation credential, and signs the entity operation credential based on first signature data to generate statement data.

In a scenario in which the target operation performed for the digital entity is the operation of transferring the digital entity, the entity operation credential generated by the terminal device may be referred to as an entity transfer credential.

In a specific implementation, if the target object has a need to transfer a digital entity, the terminal device can generate an operation request in response to the need to transfer a digital entity. In this case, the operation request is configured for requesting to transfer the digital entity from the target object to a reference object. In other words, a holder of the digital entity is adjusted from the target object to the reference object. The target object is different from the reference object. In other words, the target operation for the digital entity is the operation of transferring the digital entity. The operation information of the target operation includes at least a digital identifier of the reference object and an entity identifier of a to-be-transferred digital entity. Then, the terminal device generates, in response to the operation request, the entity transfer credential based on the digital identifier of the target object and the operation information of the target operation. Finally, the entity transfer credential is signed based on the first signature data of the target object to generate the statement data.

As described in the embodiment shown in FIG. 3 above, if the entity transfer credential is generated by the server, for example, the server invokes a third-party authority to generate the entity transfer credential, then the terminal device can send the operation request to the server, and the server invokes the third-party authority to generate the entity transfer credential in response to the operation request. A specific implementation process in which the server generates the entity transfer credential is not limited herein.

S702: The terminal device generates a transfer request based on the entity transfer credential and sends the transfer request to the server. The transfer request carries the signed entity transfer credential (that is, the statement data).

S703: The server performs signature verification processing on the statement data in response to the transfer request.

In operation S702 and operation S703, when the server obtains the transfer request, the server also obtains the statement data carried by the transfer request, then the server can perform the signature verification processing on the statement data based on the digital identifier of the target object. Specifically, the digital identifier of the target object is bound with a public key of the target object, so that the server can obtain the public key of the target object, and perform the signature verification processing on the statement data based on the public key of the target object to obtain a signature verification result.

S704: The server modifies the digital identifier of the target object in an entity document of the digital entity if the signature verification is successful.

S705: The server modifies a mapping binding relationship between the entity identifier of the digital entity and the digital identifier of the target object.

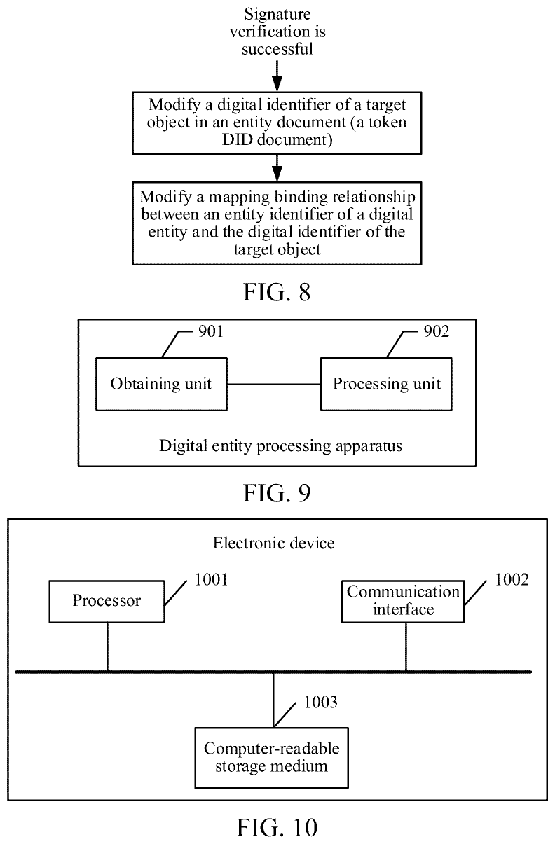

In operation S704 and operation S705, when the signature verification of the statement data is successful based on second signature data of the target object, it represents that identity verification of an entity on a terminal device side is successful. In other words, the entity on the terminal device side is the target object that uses the first signature data to digitally sign the entity transfer credential, and can perform the target operation for the digital entity. A specific implementation process of performing the target operation on the digital entity, where the target operation is the operation of transferring the digital entity, can be shown in FIG. 8. The specific process may include:

First, the entity identifier of the digital entity is parsed. The entity identifier of the digital entity is created during minting the digital entity, and the entity document corresponding to the digital entity (that is, a DID document) is obtained. The entity document stores metadata of the digital entity. The metadata includes a storage location describing content of the digital entity (such as an appearance attribute description file and a picture). The entity document further includes a controller field. The controller field records the digital identifier of the target object, and represents that an owner of the digital entity is the target object corresponding to the digital identifier recorded by the controller field.

Then, the following two operations are performed without limiting an execution sequence of the two operations, to implement transferring the digital entity from the target object to the reference object, specifically, transferring operation permission of the digital entity from the target object to the reference object, including:

\textcircled{1} In the entity document, the digital identifier of the target object recorded by the controller field is modified to a digital identifier of the reference object of a to-be-received digital entity. \textcircled{2} As described above, an NFT smart contract in a blockchain application protocol model deployed in the server stores a first mapping binding relationship. The entity identifier of the digital entity is bound with the digital identifier of the target object according to the first mapping binding relationship. Then, in a smart contract (that is, the NFT smart contract) corresponding to the digital entity, the first mapping binding relationship can be modified to a second mapping binding relationship, the first mapping binding relationship indicating that the holder of the digital entity is the target object, and the second mapping binding relationship indicating that the holder of the digital entity is the reference object.

According to the foregoing process, the transfer operation of the digital entity can be implemented, and the operation permission of the digital entity can be transferred from the target object to the reference object.

In addition, it can be learned from the foregoing descriptions that in a scenario in which the holder of the digital entity transfers the digital entity, the holder needs to issue the entity transfer credential of the digital entity to verify a change of the holder of the digital entity. In embodiments of the present disclosure, transfer effective duration is supported to be set for the entity transfer credential. In other words, the entity operation credential (or the signed statement data) is timely. The signature verification processing and a subsequent transfer operation of the entity transfer credential can only be performed within the transfer effective duration. In a specific implementation, when the first signature data of the target object is used to digitally sign the entity transfer credential, the transfer effective duration can be set for the generated statement data. The transfer effective duration can be preset or customized by the target object. In this way, after obtaining the statement data, the server can first obtain generation time of the statement data. The generation time refers to a moment when the entity operation credential of the digital entity is signed to generate the statement data. Then, target duration between the generation time of the statement data and current time is determined, and the current time refers to a moment when the signature verification processing is performed on the statement data. In other words, duration from a moment when the statement data is generated to a moment when the server performs the signature verification processing on the statement data is used as the target duration. Finally, the target duration is compared with the transfer effective duration. If the target duration is less than or equal to the transfer effective duration, it represents that the entity transfer credential is in a valid state. In this case, the operation of performing the target operation on the digital entity based on the statement data is triggered. On the contrary, if the target duration is greater than the transfer effective duration, it represents that the entity transfer credential is no longer in a valid state, but is in an invalid state. In this case, it is determined that the transfer of the digital entity is failed.

For example, in a scenario of transferring a digital entity, if statement data is generated at 12:00 on December 12, and transfer effective duration corresponding to the statement data is 24 hours, when a server performs signature verification processing on the statement data at 19:00 on December 12, it is determined that target duration between generation time of the statement data and current time is seven hours, which is less than the transfer effective duration of 24 hours. In this case, the server can perform the signature verification processing on the statement data. On the contrary, if the server performs the signature verification processing on the statement data at 12:00 on December 15, it is determined that the target duration between the generation time of the statement data and the current time is 72 hours, which is greater than the transfer effective duration of 24 hours. In this case, the server cannot perform the signature verification processing on the statement data, and it is determined that the transfer of the digital entity is failed. The transfer effective duration is set for the entity operation credential to enable the entity operation credential to have an effective operation range. This can improve security of the entity operation credential to some extent.

S706: The server returns a transfer result for the digital entity to the terminal device.

In a specific implementation, the server can return the transfer result for the digital entity to the terminal device. The transfer result for the digital entity here may include information such as successful transfer or unsuccessful transfer. Specific content included in the transfer result is not limited in embodiments of the present disclosure.

In embodiments of the present disclosure, if the target object has a need to transfer a digital entity, the terminal device can generate an operation request in response to the need to transfer a digital entity. In this case, the operation request is configured for requesting to adjust the holder of the digital entity from the target object to the reference object. The target object is different from the reference object. In other words, the target operation for the digital entity is the operation of transferring the digital entity. The operation information of the target operation includes at least a digital identifier of the reference object and an entity identifier of a to-be-transferred digital entity. Then, the terminal device generates, in response to the operation request, the entity transfer credential based on the digital identifier of the target object and the operation information of the target operation. Finally, the entity transfer credential is signed based on the first signature data of the target object to generate the statement data. Further, during transferring the digital entity, blockchain identity layer protocol (that is, a DID protocol) support is provided for an NFT protocol layer. This not only improves an autonomous control capability for the digital entity, but also improves security of digital entity transfer, and provides protocol support with entity circulation under cross-blockchain (that is, different blockchains) or cross-contract (such as different smart contracts).

The method in embodiments of the present disclosure is described in detail above. For case of better implementing solutions in embodiments of the present disclosure, correspondingly, the following provides an apparatus in embodiments of the present disclosure.

FIG. 9 is a schematic diagram of a structure of a digital entity processing apparatus according to an embodiment of the present disclosure. The processing apparatus may be mounted in an electronic device (such as a server) provided in embodiments of the present disclosure. In some embodiments, the processing apparatus may be a computer program (including program code) running on the electronic device. The processing apparatus may be configured to perform the corresponding operations in the method embodiments shown in FIG. 3, FIG. 5, or FIG. 7. Refer to FIG. 9. The processing apparatus may include the following units:
an obtaining unit 901, configured to obtain, when an operation request initiated by a target object for a digital entity is obtained, a digital identifier of the target object, the operation request carrying operation information of a target operation requested by the target object to be performed for the digital entity; and
a processing unit 902, configured to generate an entity operation credential based on the digital identifier of the target object and the operation information, the entity operation credential being configured for indicating a request to perform the target operation on the digital entity, and being configured for indicating that a requester of the target operation is the target object,
the processing unit 902 being further configured to obtain statement data if the target object confirms that the target operation is performed on the digital entity, the statement data being obtained by signing the entity operation credential using first signature data of the target object, and
the processing unit 902 being further configured to perform the target operation on the digital entity based on the statement data.

In one embodiment, the digital identifier of the target object is bound with second signature data of the target object. That the processing unit 902 is configured to perform the target operation on the digital entity based on the statement data is specifically:
obtaining the second signature data of the target object based on the digital identifier of the target object;
performing signature verification processing on the statement data by using the second signature data of the target object; and
performing the target operation on the digital entity if the signature verification of the statement data is successful.

In one embodiment, the operation request is configured for requesting to mint the digital entity, the target operation includes an operation of minting the digital entity, and the operation information of the target operation includes entity minting information required for minting the digital entity.

That the processing unit 902 is configured to perform the target operation on the digital entity is specifically:
minting the digital entity based on the entity minting information required for minting the digital entity;
creating an entity identifier for the minted digital entity; and
binding the entity identifier of the digital entity and the digital identifier of the target object.

In one embodiment, that the processing unit 902 is configured to bind the entity identifier of the digital entity and the digital identifier of the target object is specifically:
establishing a first mapping binding relationship based on the digital identifier of the target object and the entity identifier of the digital entity, the first mapping binding relationship being configured for indicating that a holder of the digital entity is the target object; and
storing the first mapping binding relationship in a smart contract corresponding to the digital entity.

In one embodiment, the operation request is configured for requesting to transfer the digital entity from the target object to a reference object, the reference object being different from the target object. The target operation includes an operation of transferring the digital entity, and the operation information of the target operation includes at least a digital identifier of the reference object and the entity identifier of the digital entity.

That the processing unit 902 is configured to perform the target operation on the digital entity is specifically:
obtaining an entity document corresponding to the digital entity, the entity document including a controller field, and the controller field recording the digital identifier of the target object;
modifying, in the entity document, the digital identifier of the target object recorded in the controller field to the digital identifier of the reference object; and
modifying, in the smart contract corresponding to the digital entity, the first mapping binding relationship to a second mapping binding relationship, the first mapping binding relationship indicating that the holder of the digital entity is the target object, and the second mapping binding relationship indicating that the holder of the digital entity is the reference object.

In one embodiment, that the processing unit 902 is configured to obtain an entity document corresponding to the digital entity is specifically:
parsing the entity identifier of the digital entity to obtain the entity document corresponding to the digital entity, the entity document storing metadata of the digital entity.

In one embodiment, the statement data has transfer effective duration. The processing unit 902 is further configured to:
obtain generation time of the statement data, the generation time being a moment when the entity operation credential of the digital entity is signed to generate the statement data;
determine target duration between the generation time of the statement data and current time, the current time being a moment when the signature verification processing is performed on the statement data; and
trigger, if the target duration is less than or equal to the transfer effective duration, the operation of performing the target operation on the digital entity based on the statement data.

In one embodiment, that the processing unit 902 is configured to obtain, if the target object confirms that the target operation is performed on the digital entity, statement data obtained by signing the entity operation credential using first signature data of the target object is specifically:
transmitting the entity operation credential to the target object to enable the target object to use, when the target object confirms that the target operation is performed on the digital entity, the first signature data of the target object to sign the entity operation credential to obtain the statement data; and
receiving the statement data returned by the target object.

In one embodiment, that the processing unit 902 is configured to obtain, if the target object confirms that the target operation is performed on the digital entity, statement data obtained by signing the entity operation credential using first signature data of the target object is specifically:
displaying the entity operation credential on a display screen;
obtaining a signed entity operation credential in response to a signature operation of the target object for the entity operation credential; and using the signed entity operation credential as the statement data.

In one embodiment, that the processing unit 902 is configured to obtain a signed entity operation credential in response to a signature operation of the target object for the entity operation credential is specifically:
obtaining the signed entity operation credential in response to a signature operation performed by the target object on the entity operation credential using the first signature data of the target object; or
receiving an authorization operation of the target object for the entity operation credential, obtaining the first signature data of the target object, and using the first signature data of the target object to sign the entity operation credential to obtain the signed entity operation credential.

In one embodiment, a generation process of the digital identifier of the target object includes:
obtaining object information of the target object; and
converting the object information into the digital identifier of the target object,
the object information including a public key of the target object.

According to an embodiment of the present disclosure, units of the processing apparatus shown in FIG. 9 may be separately or wholly combined into one or a plurality of other units, or one (or more) of the units here may further be divided into the plurality of units of smaller functions. In this way, same operations can be implemented, and implementation of the technical effects of embodiments of the present disclosure is not affected. The foregoing units are divided based on logical functions. In actual application, a function of one unit may be implemented by the plurality of units, or functions of the plurality of units are implemented by one unit. In another embodiment of the present disclosure, the processing apparatus may also include another unit. In actual application, these functions may alternatively be cooperatively implemented by another unit and may be cooperatively implemented by a plurality of units. According to another embodiment of the present disclosure, the processing apparatus shown in FIG. 9 may be constructed and the digital entity processing method in embodiments of the present disclosure may be implemented by running a computer program (including program code) that can perform the operations related to the corresponding methods shown in FIG. 3, FIG. 5, and FIG. 7 on processing elements and memory clements including a central processing unit (CPU), a random access memory (RAM), a read-only memory (ROM), and the like, for example, a generic computing device of a computer. The computer program may be recorded in, for example, a computer-readable recording medium, and may be loaded into the foregoing computing device by using the computer-readable recording medium, and run in the computing device.

In embodiments of the present disclosure, when an operation request initiated by a target object for a digital entity is received, an entity operation credential can be generated based on a digital identifier of the target object and operation information carried in the operation request. In addition, the entity operation credential indicates a request to perform a target operation on the digital entity, and indicates that a requester of the target operation is the target object. The entity operation credential of the digital entity is generated to intuitively inform the target object of information related to the digital entity, thereby optimizing expression and readability of the digital entity. In addition, only when the target object confirms that the target operation is performed on the digital entity, that is, the statement data (that is, the signed entity operation credential) is obtained, and signature verification of the statement data is successful, the target operation is performed on the digital entity. In the embodiments of the present disclosure, the digital identifier of the target object is used throughout an operation process of the digital entity, and the entity operation credential and the statement data are generated based on the digital identifier of the target object. In this way, during performing the target operation on the digital entity, the related operation performed for the digital entity and an execution object of the related operation are intuitively and reliably recorded, thereby improving security and traceability of the digital entity, and further efficiently implementing the target operation for the digital entity.

FIG. 10 is a schematic diagram of a structure of an electronic device according to an exemplary embodiment of the present disclosure. Refer to FIG. 10. The electronic device includes a processor 1001, a communication interface 1002, and a computer-readable storage medium 1003. The processor 1001, the communication interface 1002, and the computer-readable storage medium 1003 may be connected via a bus or in another manner. The communication interface 1002 is configured to receive and send data. The computer-readable storage medium 1003 may be stored in a memory of the electronic device. The computer-readable storage medium 1003 is configured to store a computer program including program instructions. The processor 1001 is configured to execute the program instructions stored in the computer-readable storage medium 1003. The processor 1001 (or referred to as a central processing unit (CPU)) is a computing core and a control core of the electronic device, is configured to implement one or more instructions, and is specifically configured to load and execute the one or more instructions to implement a corresponding method flow or a corresponding function.

An embodiment of the present disclosure further provides a computer-readable storage medium (memory), which is a memory device in the electronic device for storing a program and data. The computer-readable storage medium here may include an internal storage medium of the electronic device, and may also include an expanded memory medium supported by the electronic device. The computer-readable storage medium provides storage space that stores a processing system of the electronic device. In addition, one or more instructions that are loaded and executed by the processor 1001 are also stored in the storage space. These instructions may be one or more computer programs (including program code). The computer-readable storage medium here may be a high-speed RAM memory, or a non-volatile memory, for example, at least one magnetic disk storage. In one embodiment, the computer-readable storage medium may be at least one computer-readable storage medium that is located far away from the foregoing processor.

In one embodiment, one or more instructions are stored in the computer-readable storage medium. The processor 1001 loads and executes the one or more instructions stored in the computer-readable storage medium to implement the corresponding operations in the foregoing digital entity processing method embodiments. In a specific implementation, the one or more instructions in the computer-readable storage medium are loaded by the processor 1001 to perform the operations related to the corresponding methods shown in FIG. 3, FIG. 5, and FIG. 7.

An embodiment of the present disclosure further provides a computer program product or a computer program, the computer program product or the computer program including computer instructions, which are stored in a computer-readable storage medium. A processor of an electronic device reads the computer instructions from the computer-readable storage medium, and the processor executes the computer instructions, so that the electronic device performs the foregoing digital entity processing method.

As disclosed, when an operation request initiated by a target object for a digital entity is received, an entity operation credential can be generated based on a digital identifier of the target object and operation information carried in the operation request. In addition, the entity operation credential indicates a request to perform a target operation for the digital entity, and indicates that a requester of the target operation is the target object. The entity operation credential of the digital entity is generated to enable the target object to obtain the entity operation credential, so that the target object can be intuitively informed of information related to the digital entity based on the entity operation credential, thereby optimizing expression and readability of the digital entity. In addition, only when the target object confirms that the target operation is performed on the digital entity, that is, the statement data (that is, the signed entity operation credential) is obtained, and signature verification of the statement data is successful, the target operation is performed on the digital entity. In the embodiments of the present disclosure, the digital identifier of the target object is used throughout an operation process of the digital entity, and the entity operation credential and the statement data are generated based on the digital identifier of the target object. In this way, during performing the target operation on the digital entity, the related operation performed for the digital entity and an execution object of the related operation are intuitively and reliably recorded, thereby ensuring security of the digital entity and traceability of the related operation.

A person of ordinary skill in the art may be aware that, in combination with the examples described in embodiments disclosed in the present disclosure, units and algorithm operations may be implemented by electronic hardware or a combination of computer software and electronic hardware. Whether the functions are executed in a mode of hardware or software depends on particular applications and design constraint conditions of the technical solutions. An object skilled in the art may use different methods to implement the described functions for each particular application, but it is not to be considered that the implementation goes beyond the scope of the present disclosure.

The term unit (and other similar terms such as subunit, module, submodule, etc.) in the present disclosure may refer to a software unit, a hardware unit, or a combination thereof. A software unit (e.g., computer program) may be developed using a computer programming language. A hardware unit may be implemented using processing circuitry and/or memory. Each unit can be implemented using one or more processors (or processors and memory). Likewise, a processor (or processors and memory) can be used to implement one or more units. Moreover, each unit can be part of an overall unit that includes the functionalities of the unit.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When computer program instructions are loaded and executed on a computer, all or some of the processes or functions according to embodiments of the present disclosure are produced. The computer may be a general-purpose computer, a dedicated computer, a computer network, or another programmable device. The computer instructions can be stored in, or transmitted through, the computer-readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data processing device, for example, a server or a data center, integrating one or more usable media. The usable medium may be a magnetic medium (for example, a soft disk, a hard disk, or a magnetic tape), an optical medium (for example, a DVD), a semiconductor medium (for example, a solid-state drive (SSD)), or the like.

The foregoing descriptions are merely specific implementations of the present disclosure, but are not intended to limit the protection scope of the present disclosure. Any variation or replacement readily figured out by an object skilled in the art within the technical scope disclosed in the present disclosure shall fall within the protection scope of the present disclosure. Therefore, the protection scope of the present disclosure shall be subject to the protection scope of the claims.

What is claimed is:

1. A digital entity processing method, performed by an electronic device, the method comprising:
obtaining, when an operation request initiated by a target object for a digital entity is obtained, a digital identifier of the target object, the operation request carrying operation information of a target operation requested by the target object performing for the digital entity;
generating an entity operation credential based on the digital identifier of the target object and the operation information, the entity operation credential indicating a request for performing the target operation for the digital entity, and indicating that a requester of the target operation is the target object;
obtaining statement data in response to the target object confirming that the target operation is performed on the digital entity, the statement data being obtained by signing the entity operation credential using first signature data of the target object; and
performing the target operation on the digital entity based on the statement data.

2. The method according to claim 1, wherein second signature data of the target object is bound with the digital identifier of the target object, and performing the target operation on the digital entity based on the statement data comprises:
obtaining the second signature data of the target object based on the digital identifier of the target object;
performing signature verification processing on the statement data by using the second signature data of the target object; and
performing the target operation on the digital entity if the signature verification of the statement data is successful.

3. The method according to claim 1, wherein the operation request is configured for requesting to mint the digital entity, the target operation comprises an operation of minting the digital entity, and the operation information of the target operation comprises entity minting information required for minting the digital entity; and
performing the target operation on the digital entity comprises:
minting the digital entity based on the entity minting information required for minting the digital entity;
creating an entity identifier for the minted digital entity; and
binding the entity identifier of the digital entity and the digital identifier of the target object.

4. The method according to claim 3, wherein binding the entity identifier of the digital entity and the digital identifier of the target object comprises:
establishing a first mapping binding relationship based on the digital identifier of the target object and the entity identifier of the digital entity, the first mapping binding relationship indicating that a holder of the digital entity is the target object; and
storing the first mapping binding relationship in a smart contract corresponding to the digital entity.

5. The method according to claim 1, wherein the operation request is configured for requesting to transfer the digital entity from the target object to a reference object, the reference object being different from the target object; the target operation comprises an operation of transferring the digital entity, and the operation information of the target operation comprises at least a digital identifier of the reference object and the entity identifier of the digital entity; and
performing the target operation on the digital entity comprises:
obtaining an entity document corresponding to the digital entity, the entity document comprising a controller field, and the controller field recording the digital identifier of the target object;
modifying, in the entity document, the digital identifier of the target object recorded in the controller field to the digital identifier of the reference object; and
modifying, in the smart contract corresponding to the digital entity, the first mapping binding relationship to a second mapping binding relationship, the first mapping binding relationship indicating that the holder of the digital entity is the target object, and the second mapping binding relationship indicating that the holder of the digital entity is the reference object.

6. The method according to claim 5, wherein obtaining the entity document corresponding to the digital entity comprises:
parsing the entity identifier of the digital entity to obtain the entity document corresponding to the digital entity, the entity document storing metadata of the digital entity.

7. The method according to claim 5, wherein the statement data has transfer effective duration;
and the method further comprises:
obtaining generation time of the statement data, the generation time being a moment when the entity operation credential is signed to generate the statement data;
determining target duration between the generation time of the statement data and current time, the current time being a moment when the signature verification processing is performed on the statement data; and
triggering, if the target duration is less than or equal to the transfer effective duration, the operation of performing the target operation on the digital entity based on the statement data.

8. The method according to claim 1, wherein obtaining statement data if the target object confirms that the target operation is performed on the digital entity comprises:
transmitting the entity operation credential to the target object to enable the target object to use, when the target object confirms that the target operation is performed on the digital entity, the first signature data of the target object to sign the entity operation credential to obtain the statement data; and
receiving the statement data returned by the target object.

9. The method according to claim 1, wherein obtaining the statement data if the target object confirms that the target operation is performed on the digital entity comprises:
displaying the entity operation credential on a display screen;
obtaining a signed entity operation credential in response to a signature operation of the target object for the entity operation credential; and
using the signed entity operation credential as the statement data.

10. The method according to claim 9, wherein obtaining the signed entity operation credential in response to the signature operation of the target object for the entity operation credential comprises:
obtaining the signed entity operation credential in response to a signature operation performed by the target object on the entity operation credential using the first signature data of the target object; or
receiving an authorization operation of the target object for the entity operation credential, obtaining the first signature data of the target object, and using the first signature data of the target object to sign the entity operation credential to obtain the signed entity operation credential.

11. The method according to claim 1, wherein a generation process of the digital identifier of the target object comprises:
obtaining object information of the target object; and
converting the object information into the digital identifier of the target object, the object information comprising a public key of the target object.

12. An electronic device, comprising: at least one processor, configured to execute a computer program; and
a memory storing the computer program that, when being executed, causes the at least one processor to perform:
obtaining, when an operation request initiated by a target object for a digital entity is obtained, a digital identifier of the target object, the operation request carrying operation information of a target operation requested by the target object performing for the digital entity;
generating an entity operation credential based on the digital identifier of the target object and the operation information, the entity operation credential indicating a request for performing the target operation for the digital entity, and indicating that a requester of the target operation is the target object;
obtaining statement data in response to the target object confirming that the target operation is performed on the digital entity, the statement data being obtained by signing the entity operation credential using first signature data of the target object; and
performing the target operation on the digital entity based on the statement data.

13. The device according to claim 12, wherein second signature data of the target object is bound with the digital identifier of the target object, and the at least one processor is further confirmed to perform:
obtaining the second signature data of the target object based on the digital identifier of the target object;
performing signature verification processing on the statement data by using the second signature data of the target object; and
performing the target operation on the digital entity if the signature verification of the statement data is successful.

14. The device according to claim 12, wherein the operation request is configured for requesting to mint the digital entity, the target operation comprises an operation of minting the digital entity, and the operation information of the target operation comprises entity minting information required for minting the digital entity; and
the at least one processor is further confirmed to perform:
minting the digital entity based on the entity minting information required for minting the digital entity;
creating an entity identifier for the minted digital entity; and
binding the entity identifier of the digital entity and the digital identifier of the target object.

15. The device according to claim 14, wherein the at least one processor is further confirmed to perform:
establishing a first mapping binding relationship based on the digital identifier of the target object and the entity identifier of the digital entity, the first mapping binding relationship indicating that a holder of the digital entity is the target object; and
storing the first mapping binding relationship in a smart contract corresponding to the digital entity.

16. The device according to claim 12, wherein the operation request is configured for requesting to transfer the digital entity from the target object to a reference object, the reference object being different from the target object; the target operation comprises an operation of transferring the digital entity, and the operation information of the target operation comprises at least a digital identifier of the reference object and the entity identifier of the digital entity; and
the at least one processor is further confirmed to perform:
obtaining an entity document corresponding to the digital entity, the entity document comprising a controller field, and the controller field recording the digital identifier of the target object;
modifying, in the entity document, the digital identifier of the target object recorded in the controller field to the digital identifier of the reference object; and
modifying, in the smart contract corresponding to the digital entity, the first mapping binding relationship to a second mapping binding relationship, the first mapping binding relationship indicating that the holder of the digital entity is the target object, and the second mapping binding relationship indicating that the holder of the digital entity is the reference object.

17. The device according to claim 16, wherein the at least one processor is further confirmed to perform:
parsing the entity identifier of the digital entity to obtain the entity document corresponding to the digital entity, the entity document storing metadata of the digital entity.

18. The device according to claim 16, wherein the statement data has transfer effective duration; and the at least one processor is further confirmed to perform:
obtaining generation time of the statement data, the generation time being a moment when the entity operation credential is signed to generate the statement data;
determining target duration between the generation time of the statement data and current time, the current time being a moment when the signature verification processing is performed on the statement data; and
triggering, if the target duration is less than or equal to the transfer effective duration, the operation of performing the target operation on the digital entity based on the statement data.

19. The device according to claim 12, wherein the at least one processor is further confirmed to perform:
transmitting the entity operation credential to the target object to enable the target object to use, when the target object confirms that the target operation is performed on the digital entity, the first signature data of the target object to sign the entity operation credential to obtain the statement data; and
receiving the statement data returned by the target object.

20. A non-transitory computer-readable storage medium, containing a computer application program that, when being executed, causes a computer to perform:
obtaining, when an operation request initiated by a target object for a digital entity is obtained, a digital identifier of the target object, the operation request carrying operation information of a target operation requested by the target object performing for the digital entity;
generating an entity operation credential based on the digital identifier of the target object and the operation information, the entity operation credential indicating a request for performing the target operation for the digital entity, and indicating that a requester of the target operation is the target object;
obtaining statement data in response to the target object confirming that the target operation is performed on the digital entity, the statement data being obtained by signing the entity operation credential using first signature data of the target object; and
performing the target operation on the digital entity based on the statement data.
